(19) United States
(12) Patent Application Publication
(10) Pub. No.: US 2001/0038330 A1
(43) Pub. Date: Nov. 8, 2001

(54) Personal item theft deterrent and reminder system

(76) Inventor: Anthony M. Garcia, North Hills, CA (US)

Correspondence Address: ROBERT J. SCHAAP, Suite 188, Ventura Boulevard, Woodland Hills, CA, 91364, US

(21) Appl. No.: 09/847,740

(22) Filed: May 2, 2001

Related U.S. Application Data
(60) Provisional application No. 60/201,833, filed on May 3, 2000.

(51) Int. Cl. G08B 13/14

(52) U.S. Cl. 340/568.1; 340/568.2; 340/568.4; 340/571; 340/539; 340/686.6

(57) ABSTRACT

A personal item theft deterrent system which sets forth two individual embodiments and one of which relies upon a physical attachment of a personal item to an individual as, for example, through a cord or cable. The other of the embodiments relies upon a wireless and uncoupled alarm responsive system. In the embodiment using a physical attachment, a cord or cable is connected to the personal item and to the individual to whom the personal item belongs by a tether or cord and preferably a decorative cord. A tensioning device which places tension on the cord is incorporated with the cord so that the user can sense someone attempting to move the personal item. In the second embodiment, a transmitter is located in or on the personal item and sends a proximity signal to a receiver located at or with the owner of the person item. When the personal item is moved beyond a pre-selected distance away from the owner, the signal from the transmitter will become weaker and a circuit in a device in the proximity of the owner will cause the generation of an alarm signal.

### BACKGROUND OF THE INVENTION

1. Field of the Invention

This invention relates in general to certain new and use improvements in personal item theft deterrent and reminder systems and, more particularly, to a theft deterrent and reminder system of the type which will initiate a triggering signal or an alarm signal to an owner of a personal item in the event that the owner and the personal item are separated by more than a predetermined distance.

2. Brief Description of Related Art

Many people frequently carry personal items with them, particularly in business activities or shopping activities or the like, and often in a pedestrian mode of travel. A shopper, for example, may carry one or more shopping bags of acquired merchandise. A businessperson may carry a briefcase, computer case or like carrying case.

The pedestrian individual may often elect to find a location to rest for a brief period of time and perhaps obtain a meal or the like. In that situation, the pedestrian individual may place their packages, such as shopping bags, wrapped boxes, or briefcases, in a location adjacent to where they are sitting or resting.

Very frequently, the same pedestrian individual will forget about the package that he or she has placed adjacent their position of sitting or resting and walk off without their package. The loss of this package, such as, for example, a briefcase, can have serious consequences, even for a loss in few day period.

Another one of the problems associated with the leaving of a package is that of theft. When in a public location as, for example, an airport or a train station or the like, a traveler may place a briefcase or suitcase or like carrying case adjacent to where the traveler is sitting and, perhaps, waiting for the travel to commence. Very frequently, this type of person carrying a package, such as carrying case, will occupy his or time by reading and thereby completely lose attention to the fact that they have a carrying case adjacent to that person. The astute thief will recognize the inattentiveness of that person and literally walk off with their package.

The above examples illustrate only a few situations in which a personal belonging can be either forgotten or become the subject of a theft. There are obviously numerous other situations in which personal belongings can be either left behind or stolen.

There are numerous U.S. patents which show the concept of triggering an alarm when a cord between an individual and that individual's belonging is placed under tension. U.S. Pat. No. 5,408,213 to Ungarsohn discloses, for example, the use of a magnetic switch which is actuated when the cord is pulled. In particular, reference is also made to U.S. Pat. No. 4,633,232 to Nelson, et al, U.S. Pat. No. 5,915,631 to Laxton, et al, U.S. Pat. No. 5,408,220 to Brown, et al.

It is therefore desirable to provide some means for alerting an individual who may be inattentive to his or her belongings to the fact that they may have been left behind or are rapidly becoming the subject of a theft.

### OBJECTS OF THE INVENTION

It is, therefore, one of the primary objects of the present invention to provide a system which is capable of alerting an individual to the fact that a belonging of that individual may have been left behind or may be the subject of a theft as a result of inattention.

It is another object of the present invention to provide a theft deterrent and reminder system which, in one embodiment, relies upon the use of a cable paid out from a supply reel and which may include a tensioning means therefor.

It is a further object of the present invention to provide a personal theft deterrent and reminder system which relies upon the initiation of an alarm signal in the event that personal belonging is left behind or is taken from that individual in a state of inattentiveness.

It is an additional object of the present invention to provide a personal item theft deterrent and reminder system which is relatively simple in construction and relative inexpensive to manufacture and, therefore, highly available for use and adoption.

It is another salient object of the present invention to provide a method of deterring theft and reminding an inattentive individual of the fact that belongings may have been left behind or are otherwise becoming the subject of a theft.

With the above and other objects in view, my invention resides in the novel features of form, construction, arrangement and combination of parts and components presently described and pointed out in the claims.

### BRIEF SUMMARY OF THE INVENTION

A personal theft deterrent and reminder system which alerts an individual to the fact that that individual may be leaving behind a possession of that individual or, otherwise, of the fact that a belonging of that individual may become the subject of a theft. The present invention discloses two unique embodiments for accomplishing this result. One of the embodiments does not rely upon an alarm but rather a upon a tugging of a portion of the individual. The other of the embodiments relies upon a wireless alarm which is generated.

In the first of the embodiments, a simple cord extends between the individual and the personal item or belonging. However, in this embodiment, there is a pay-out reel which pays out the cord for a specific length. At the end of the length of the cord, the individual who is leaving behind a personal item or in which a thief is attempting to walk off with that item, a tug will occur on the individual. Thus, the individual may wear a wrist band with the cord attached to that wrist band. When a tug occurs on the cord, the individual will quickly recognize the fact that they have left the item or that the item has been moved beyond their immediate location.

In the above-identified embodiment, there is no need for an alarm, since the individual is alerted through the tug on a portion of his or her body. However, if desired, an alarm can also be incorporated.

In another embodiment of the invention, a transmitter is located in the personal belonging as, for example, a briefcase. The individual wears a receiver. A circuit is employed to generate an alarm signal when the individual and his or her belonging is separated by a predetermined distance. Alternatively, the individual could wear a transmitter and the receiver could be located at the personal item. Moreover, an alarm can be generated at the presence of the individual or at the presence of the personal item. In the latter case, the individual can attempt to locate the presence of his or her belonging through sound.

In either of the wireless alarm activated embodiments, the individual who has left his or her belongings behind will immediately recognize that inattentiveness and failure and immediately retrieve their belongings. In the case of a theft, the thief will very likely drop the belongings that he or she is taking so as to potentially and hopefully avoid implication in a theft.

The term “personal belonging” is also effective to include individuals or animals. In the case an individual concerned with a potential kidnaping, a transmitter or receiver can be located on the child and the other of the transmitter or receiver located on the adult individual or caretaker. Again, if the child is removed, an alarm is generated. Again, the alarm can be located at the site of the child or at the site of the adult or both.

A simple circuit arrangement is provided to energize the alarm. Various embodiments of this circuit are available, although each will rely, in some fashion, upon a detection of a signal strength and generation of an alarm based on that signal strength.

This invention possesses many other advantages and has other purposes which may be made more clearly apparent from a consideration of the forms in which it may be embodied. These forms are shown in the drawings forming a part of and accompanying the present specification. They will now be described in detail for purposes of illustrating the general principles of the invention. However, it is to be understood that the following detailed description and the accompanying drawings are not to be taken in a limiting sense.

### BRIEF DESCRIPTION OF THE DRAWINGS

Having thus described the invention in general terms, reference will now be made to the accompanying drawings in which:

FIG. 1 is a schematic view of one embodiment of a personal item theft deterrent and reminder system of the invention;

FIG. 2 is a schematic view of a modified form of personal item theft deterrent and reminder system of the invention;

FIG. 3 is a schematic view of another alternative embodiment of the invention; and

FIG. 4 is a schematic electrical circuit diagram for the embodiment of FIG. 3.

### DETAILED DESCRIPTION OF A PREFERRED EMBODIMENT

The present invention relates to a personal item theft deterrent system and which also functions as a memory warning device warning an owner of a personal item that he or she may have left that item.

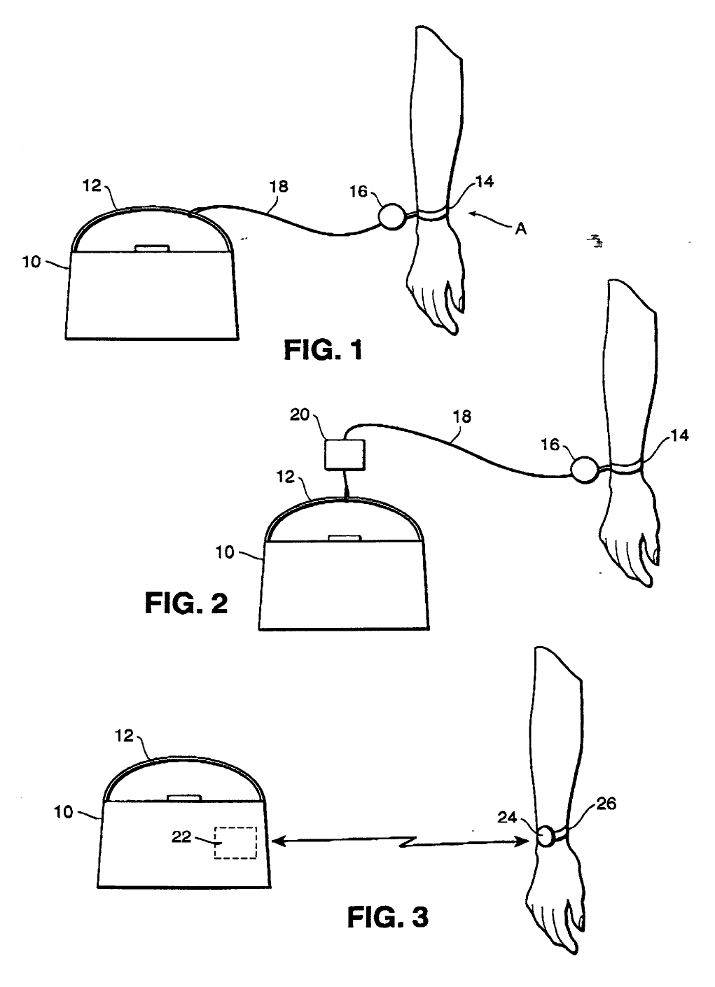

In the first embodiment of the invention, there is a theft deterrent and personal belonging reminder system A which is adapted to be worn by a user and which cooperates with an personal item, such as a handbag 10, as shown in FIG. 1. Again, it should be understood that any other personal item could be used with the present invention in place of that handbag. The typical handbag is provided with a handle 12.

The personal item theft deterrent and reminder system of the invention includes a band 14 or other item for attachment to an individual. In the embodiment as shown, the band 14 is worn about the wrist of a user, much in the nature as a wristwatch. A tensioning device 26 is connected to that band 14 and which is, in turn, connected through a tether in the form of a cord or cable 18 to the handbag 10.

The tensioning device 16 is a conventional structure which allows a pay-out of the cord or cable 18 at a controlled rate and which increases the tension on a pay-out reel included in the device as the cord is pulled out from the device. Thus, a reel under spring tension will increase the restraining force on pay-out of the cable as more cable is removed.

In accordance with this structure, the user will feel the tension imposed on the cable and recognize that he or she may have forgotten about the personal item or otherwise realize that someone is improperly attempting to remove that item. Even if the user does not immediately recognize the tug or pull on his or her body, after the tension increases to a predetermined level, the user will immediately recognize that tug and become aware of the fact that his or her belonging is not with that person.

In place of a tensioning device, a pay-out reel could be used. Thus, cable could be paid out from a reel for a relatively short distance until the reel stops as a result of no further cable capable of being paid out. Again, a combination of a reel pay-out and tensioning device is also effective in the present invention.

In a second embodiment of the invention, an alarm system could be incorporated with the device of FIG. 1. In this case, like reference numerals used in the embodiment of FIG. 1 will be used in this embodiment of FIG. 2, as well as other embodiments as hereinafter described, to represent the same component.

In the second embodiment of the invention as shown in FIG. 2, there is also provided an alarm device 20. In this particular case, the alarm device is shown in closely spaced relationship to the handbag 10, although it could be located in close proximity to the arm of the user. The alarm device 20 is essentially conventional and operates much in the manner as an electrical switch. When the cable 18 is pulled and under tension, it will effectively close a switch in the alarm device 20 and which will operate to energize an alarm through a battery source of power. Inasmuch as the actual alarm device is conventional, it is neither illustrated nor described in any further detail herein.

In a third embodiment of the invention, as shown in FIG. 3, a wireless system is provided. In this particular case, a transmitter 22, such as a radio frequency transmitter, is included in the purse 10. Naturally, it should be understood that the transmitter could be mounted on or within the purse in any fashion and in any suitable location. A receiver 24 is carried by or with the individual to whom the purse belongs. The receiver may be mounted on an arm band 26 much in the nature of a wristwatch. The receiver is operated at the same frequency as the transmitter 22.

In accordance with the arrangement as shown in FIG. 3, if the purse or other personal item is carried a predetermined distance, e.g. ten feet, beyond the location of the transmitter 22, then an alarm will be generated. Again, it should be recognized that the alarm device could be located in close proximity to the arm of the individual, as opposed to being located in proximity to the purse. Moreover, if desired, a pair of alarm devices could be provided with one located in proximity to the purse and one located in proximity to the individual.

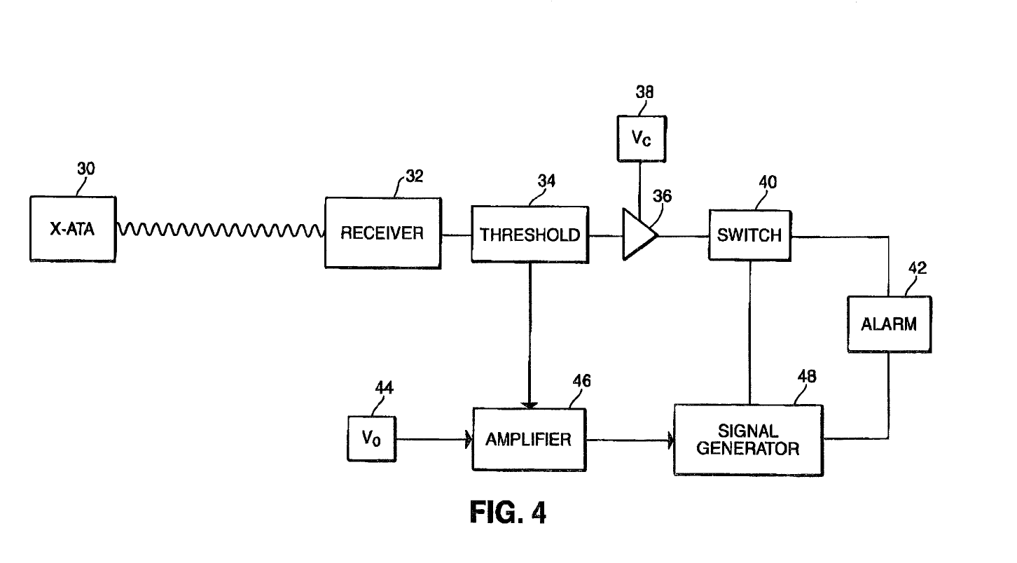

FIG. 4 illustrates an embodiment of a conventional circuit which may be used for this purpose and includes a transmitter 30 equivalent to the transmitter 22 and a receiver 32 equivalent to the receiver 24. The receiver generates an output, such as threshold level output, which is received by a threshold detector 34. In order to determine if the transmitter 30 and, hence, the personal item 10 has been moved beyond a selected distance, an output from the threshold detector 34 is introduced into a comparator 36 which may operate in the nature of an amplifier. The comparator compares its input voltage signal from the threshold detector 34 with a reference voltage signal from a voltage source 38 and designated as V_{c} and which is the reference voltage for that comparator 36. If the output is sufficiently high which suggests that the personal item is still present and not forgotten and not the subject of a theft, then no signal from the comparator is generated. On the other hand, if the signal is weaker than that of the threshold level voltage, an output is generated and is received by a switch 40. When the switch is tripped, it will generate an alarm 42.

The switch may be in the nature of a flip-flop which is automatically switched upon a lower or higher voltage condition, depending upon the construction of the flip-flop. In this case, the flip-flop would be switched to allow for an alarm condition if the purse or other item has been moved beyond the predetermined distance represented by the reference voltage signal. In like manner, no alarm would be generated if the purse or other item had not been moved beyond this predetermined distance. An inverting amplifier can also be used, if desired.

The entire circuit is powered through another voltage source 44 which may be amplified in an amplifier 46 and operates in conjunction with a signal generator 48. Inasmuch as the voltage signal from the switch 40 may not be sufficient to operate the alarm 42, the signal generator 48 provides the necessary power signal and in the presence of a signal from the switch will cause energization of the alarm 42.

Thus, there has been illustrated and described a unique and novel personal item theft deterrent and reminder system and which thereby fulfills all of the objects and advantages which have been sought. It should be understood that many changes, modifications, variations and other uses and applications which will become apparent to those skilled in the art after considering the specification and the accompanying drawings. Therefore, any and all such changes, modifications, variations and other uses and applications which do not depart from the spirit and scope of the invention are deemed to be covered by the invention.

Having thus described the invention, what we desire to claim and secure by Letters Patent is:

1. A device for reducing incidence of theft or forgetful inadvertence of an item belonging to an individual, said device comprising:
a) a cord functioning as a tether extending between the item belonging to the individual and the individual; and
b) a cord tensioning affecting device inserted between the individual and the item belonging to the individual which automatically affects the tension on the cord when a tensional force is imposed on the cord.

2. The device for reducing incidence of theft or forgetful inadvertence of an item belonging to an individual of claim 1 further characterized in that said cord tension affecting device comprises a spool upon which the cord is wound and which allows for pay-out of said cord when the tensional force is imposed on said cord.

3. The device for reducing incidence of theft or forgetful inadvertence of an item belonging to an individual of claim 1 further characterized in that said cord tension affecting device comprises a spool which is biased to increase tension as the cord is pulled.

4. The device for reducing incidence of theft or forgetful inadvertence of an item belonging to an individual of claim 1 further characterized in that said cord tension affecting device comprises a spool upon which the cord is wound and which allows for pay-out of said cord when the tensional force is imposed on said cord and means for increasing the tension on the cord as the cord is pulled from the spool.

5. The device for reducing incidence of theft or forgetful inadvertence of an item belonging to an individual of claim 1 further characterized in that an alarm is operatively connected to said device to automatically generate an alarm when a tensional force is imposed on said cord.

6. The device for reducing incidence of theft or forgetful inadvertence of an item belonging to an individual of claim 1 further characterized in that the cord is attached to the item and to the individual through a wrist band worn about the individual.

7. A device for reducing incidence of theft or forgetful inadvertence of an item belonging to an individual, said device comprising:
a) transceiver means for enabling a wireless signal to extend between said item and said individual;
b) means for measuring a level of said wireless signal and determining if said level of said wireless signal represented a distance between said item and said individual which exceeded a certain predetermined distance; and
c) an alarm device initiating an alarm if said distance between the individual and the item exceeded the predetermined distance.

8. The device for reducing incidence of theft or forgetful inadvertence of an item belonging to an individual of claim 7 further characterized in that said transceiver means comprises a transmitter at said item or said individual and a receiver at the other of said item or individual.

9. The device for reducing incidence of theft or forgetful inadvertence of an item belonging to an individual of claim 7 further characterized in that the means for measuring the level of the wireless signal comprises a receiving amplifier and a threshold detector which receives a threshold signal therefor.

10. The device for reducing incidence of theft or forgetful inadvertence of an item belonging to an individual of claim 9 further characterized in that said threshold signal is compared against the input signal from the transmitter and initiates an alarm signal if the threshold exceeded a predetermined level.

11. The device for reducing incidence of theft or forgetful inadvertence of an item belonging to an individual of claim 10 further characterized in that said alarm generates an audible signal if the distance between the individual and the item exceeded a predetermined distance.

12. A method for reducing the incidence of theft or forgetful inadvertence of an item belonging to an individual, said method comprising:
a) connecting a tether to an individual and to the item belonging to that individual; and
b) applying tension to that tether when the distance between the individual and the item belonging to that individual increases beyond a predetermined threshold level.

13. The method of claim 12 further characterized in that the method comprises allowing unwinding of said tether from a spool containing same.

14. The method of claim 12 further characterized when a distance between the item and the individual increases beyond a predetermined distance.

15. A method for reducing the incidence of theft or forgetful inadvertence of an item belonging to an individual, said method comprising:
a) creating a wireless signal between the item and the individual;
b) measuring the level of that wireless signal periodically and determining if the level of that signal represents a distance between the item and the individual which exceeds a predetermined distance; and
c) generating an alarm if the distance between the individual and the item exceeded that predetermined distance.
